(19) United States
(12) Patent Application Publication
(10) Pub. No.: US 2018/0254502 A1
(43) Pub. Date: Sep. 6, 2018

(54) CATALYST COATED MEMBRANE (CCM) FOR ALKALINE EXCHANGE MEMBRANE FUEL CELL AND METHOD OF MAKING SAME

(71) Applicant: POCELL TECH LTD., Caesarea (IL)

(72) Inventors: Shimshon GOTTESFELD, Nishyuna, NY (US); Miles PAGE, Hod Hasharon (IL)

(73) Assignee: POCELL TECH LTD., Caesarea (IL)

(21) Appl. No.: 15/927,271

(22) Filed: Mar. 21, 2018

Related U.S. Application Data
(63) Continuation-in-part of application No. 13/912,402, filed on Jun. 7, 2013, now abandoned.
Application No. 13/912,402 is a continuation-in-part of application No. 13/154,056, filed on Jun. 6, 2011.
(60) Provisional application No. 61/352,009, filed on Jun. 7, 2010.
(60) Provisional application No. 61/778,921, filed on Mar. 13, 2013.

(51) Int. Cl. H01M 8/1004; H01M 8/1041; H01M 8/1062; H01M 8/1088; H01M 4/88

(52) U.S. Cl. CPC H01M 8/1004; H01M 8/1055; H01M 2008/1095; H01M 8/1088; H01M 4/8828; H01M 8/1062

(57) ABSTRACT

A catalyst coated membrane (CCM) for an alkaline exchange membrane fuel cell may include: a membrane including at least one of: a polymer or a copolymer having a first functional chemical group; an anode catalyst layer coated on one side of the membrane including: anode catalyst nano-particles and a polymer or a copolymer having a second functional chemical group; and a cathode catalyst layer coated on a side of the membrane opposite the anode catalyst layer, including: cathode catalyst nano-particles and a polymer or a copolymer having a third functional chemical group, wherein the first functional chemical group, the second functional chemical group and the third functional chemical group are all crosslinked with the same crosslinking chemical group.

### CROSS REFERENCE TO RELATED APPLICATIONS

This application is a continuation-in-part of U.S. patent application Ser. No. 13/912,402, filed on Jun. 7, 2013, which claims the benefit of Provisional Application Ser. No. 61/778,921, filed Mar. 13, 2013, said U.S. patent application Ser. No. 13/912,402 is a continuation-in-part of U.S. Ser. No. 13/154,056, filed Jun. 6, 2011, which claims the benefit of U.S. Provisional Application No. 61/352,009, filed Jun. 7, 2010, all of which are incorporated by reference herein in their entirety.

### TECHNICAL FIELD OF THE INVENTION

This application related to catalyst coated membranes (CCM) for fuel cells. More particularly to catalyst coated membranes (CCM) for alkaline exchange membrane fuel cells.

### BACKGROUND OF THE INVENTION

The quality of the bond between the catalyst layer (CL) and the membrane is an important parameter in membrane electrolyte fuel cell technology. The interfacial contact of the CL and the cell membrane has to be continuous to the nanometer scale in order to achieve effective catalyst utilization and to minimize internal cell resistance. The critical importance of the CL-cell membrane interface has been scarcely reported. Pivovar and Kim, J Electrochem. Soc., 154 (8) B739-B744 (2007) and Kim et al., 2006 DOE OHFCIT Program Review, May 16, 2006 have presented some details on the crucial significance of the quality of CL-cell membrane interface on fuel cell performance. In the prior art, Polymer Electrolyte Membrane (PEM) fuel cell technology, the bond between catalyst and membrane is formed relatively readily, typically by hot-pressing a CL/membrane/CL combination or “sandwich”—the so called “CCM” (Catalyst-Coated Membrane). Because the perfluoro-carbon backbone of ionomers used in PEM fuel cells exhibits some thermoplasticity at temperatures below the chemical stability limit, the result of hot-pressing is typically inter-diffusion of the polymer components in the CL and in the surface of the membrane. Such inter-diffusion can generate bonding that can be described as zipping together of micro-fingers of polymeric material protruding from each side of the interface. This form of bonding can secure lasting interfacial adherence in CCMs for PEM fuel cells, typically surviving long term operation at high cell current densities and experiencing a significant number of wet-dry cycles.

Wet-dry cycles can be a major challenge to the integrity of the interfacial bond because of the dimensional changes associated with water uptake by the dry polymer material. These dimensional changes can be expected to cause significant stress in the CL/cell membrane interface and could result in gradual delamination that takes place depending, for instance, on: (i) the intrinsic strength of the as-formed interfacial bond and (ii) the dissimilarity of dimensional changes during wet-dry cycles in the materials forming the interfacial bond. In the case of the PEM fuel cell which employs ionomers with perfluoro-carbon backbones, hot pressing under well-optimized pressure and temperature conditions can help to provide a CL/cell membrane interface of good adhesion and of well-matched dimensional changes on both sides of the interface during wet-dry cycles. The strength of the as-formed bond has been confirmed in peel-strength measurements.

In contrast, with ionomers having hydrocarbon, or cross-linked hydrocarbon backbones, such as, for example, in the anion-conducting polymers developed to date, the quality of the CL/membrane interfacial bond formed by hot-pressing a thin film of catalyst/ionomer composite onto the membrane surface, is significantly less satisfactory. One reason is the negligible thermoplasticity of polymers with hydrocarbon backbones. Such polymers with hydrocarbon backbones do not achieve inter-diffusion of ionomeric components across the interface during hot-pressing at relatively low temperatures, for instance at temperatures less than 100° C. Alkaline Membrane Fuel Cells (AMFCs) based on ionomers with hydrocarbon backbones, can therefore suffer delamination at the CL/membrane interface that can become a major cause of performance loss and can lead to complete cell failure. Clearly, the negligible thermoplasticity of the poly[hydrocarbon] ionomers employed in the AMFC membrane and CL calls for alternative methods and structures for securing high quality CL/membrane bonds.

Cross-linking can provide excellent chemical bonding between poly[hydrocarbon] chains. Various cross-linking methods were used in membrane preparation for AMFCs. Xu and Zha [J. Membrane Sci., 199 (2002) 203-210], Park et al. [Macromol. Symp. (2007) 249-250, 174-182] and Robertson et al. [J. Am. Chem. Soc. (2010), 132, 3400-3404] used different diamine compounds to cross-link the polymer in membranes for Alkaline Membrane Fuel Cell (AMFC). Although membranes with cross-linked polymers exhibited excellent mechanical strength, after cross-linking, the membrane surface becomes rigid with very poor surface properties. Similar cross-linking approach within the membrane was applied by Wu et al. [J. Appl. Polymer Sci., 107 (2008) 1865-1871] using UV/thermal curing instead of diamine compounds. Quality of the cross-linked membrane surface, however, did not allow applying a CL on the membrane surface, consequently obtaining inadequate CL-cell membrane-CL interface bond quality.

Similarly to the approach of cross-linking the polymer material in the membrane alone, Varcoe and Slade [Electrochem. Comm., 8 (2006) 839-843] have cross-linked the polymer in the CL alone and mechanically pressed the electrode with such cross-linked CL onto an anion exchange membrane. Similar to other earlier studies of AMFCs, they also obtained poor CL-cell membrane bonding and concluded that inadequate CL-cell membrane interfaces are major limiters of power performance in AMFCs.

In contrast to all those approaches, the present disclosure provides a method of chemically bonding together a CL and an alkaline cell membrane of an AMFC wherein a chemical bond is created across the interface between the CL and the membrane and further, across the whole CCM when the CCM is prepared from membrane in precursor form catalyzed on both sides with catalyst layers containing ionomer also in precursor form. As used herein, a polymer in a precursor form is a polymer not yet ionized.

While this section of this application is labeled as “Background” Applicants provide this description as information that helps to explain the invention disclosed herein. Unless explicitly stated, Applicant does not concede that anything described in this section, or any other part of this application, is prior art, or was known before the date of conception of the invention described herein.

### SUMMARY OF THE INVENTION

In general, in an aspect, embodiments of the invention may provide an alkaline membrane fuel cell including at least one of i) a catalyst coated OH— ion conducting membrane having a catalyst layer and an OH— ion conducting membrane, and ii) a catalyst coated carbonate ion conducting membrane having a catalyst layer and a carbonate ion conducting membrane, respectively, wherein the at least one catalyst layer is chemically bonded to a surface of the at least one membrane, wherein the chemical bonding is established by cross-linking of polymer constituents across an interface between the at least one catalyst layer and the at least one membrane.

Implementations of the invention may include one or more of the following features. An overall cross-linking region includes at least some volume of the catalyst layer. An immobilized cation in the conducting membrane is based on at least one of quaternary phosphonium and quaternary ammonium groups. The cross-linking is established using diphosphines, triphosphines, monophosphine and diphosphines mixtures, diamines, triamines, monoamine and diamine mixtures, and any phosphine or amine having the general formula: (R1R2)X—R—X(R3R4) where X is a P or N atom, R1 and R2, R3 and R4 are C1-C6 alkyl groups, independent of each other or forming a ring with each other; and R includes a spacer in the molecular structure selected to optimize the length of the polymer molecule. The cross-linking is established through a thin film pre-applied between the catalyst layer and the conducting membrane. The cross-linking is based on ionic attractive forces introduced using a thin polymer film with acidic functions, placed between the catalyst layer and the conducting membrane. The cross-linking is established using UV activated cross-linking agents. The UV initiated cross-linking is established through a thin film pre-placed between the catalyst layer and the conducting membrane. The cross-linking is established using thermally activated cross-linking agents. The thermal initiated cross-linking is established through a thin film pre-placed between the catalyst layer and the conducting membrane.

In general, in an aspect, embodiments of the invention may provide a method of forming a catalyst-coated membrane for an alkaline membrane fuel cell, the method including chemically bonding a catalyst layer to at least one of an i) OH— ion conducting membrane, and ii) a carbonate ion conducting membrane, by establishing cross-linking of polymer constituents across an interface between the catalyst layer and a surface of the at least one membrane, pre-treating the at least one cell membrane surface by at least one of: i) roughening the at least one membrane surface using micro-particle sand blasting, and ii) swelling of a portion of the at least one membrane surface by contacting the portion with a solvent suitable for inducing swelling. Implementations of the invention may provide one or more of the following features. The method further includes basing an immobilized cation in the conducting membrane on at least one of quaternary phosphonium and quaternary ammonium groups. The method further includes cross-linking using diphosphines, triphosphines, monophosphine and diphosphines mixtures, diamines, triamines, monoamine and diamine mixtures, and any phosphine or amine having the general formula: (R1R2)X—R—X(R3R4) where X is a P or N atom, R1 and R2, R3 and R4 are C1-C6 alkyl groups, independent of each other or forming a ring with each other; and R includes a spacer in the molecular structure selected to optimize the length of the polymer molecule. The method further includes cross-linking through a thin film pre-applied between the catalyst layer and the conducting membrane. The cross-linking is based on ionic forces introduced using a thin polymer film with acidic functions, placed between the catalyst layer and the conducting membrane. Wherein cross-linking is established using UV activated cross-linking agents. Wherein cross-linking is established using thermally activated cross-linking agents.

Various methods and processes for chemically bonding catalyst layers to cell membranes of alkaline membrane fuel cells are provided and, more particularly, for creating chemical bonds across the interface between a catalyst layer and a surface of a cell membrane.

Applicants have developed two approaches to help to achieve high quality bonds at the interface of catalyst layers and cell membranes of AMFCs including: (1) a bond based on embedding solid catalyst particles into the membrane surface to generate “anchor sites” for a CL, and (2) a chemical bond created at the interface between a CL and a cell membrane and, more particularly, between the functional groups in the membrane surface and the counterpart functional groups at the near-(membrane) surface region of the recast ionomer(s) of the CL.

The former approach is disclosed in applicant's co-pending U.S. patent application Ser. No. 12/710,539 filed Feb. 23, 2010, which is incorporated by reference herein in its entirety, that discloses methods of applying a catalyst based on nano-metal particles to the hydrocarbon membrane surface. Such methods have been shown to generate high performance at minimal ionomer content in the CL. Such an ionomer-lean, nano-metal particle-rich catalyst likely bonds to a cell membrane via solid particle anchor sites embedded into the membrane surface when the catalyst coated membrane (CCM) is pressed.

The second approach is in accordance with the invention described below and includes creating and forming interfacial chemical bonds between cell membrane surface functionalities and recast ionomer counterpart functionalities. Such methods and processes to achieve chemical bonding at the CL/membrane interface are disclosed in the present application. The methods and processes according to the invention are generally disclosed and grouped in this Summary section, as provided below, with further details provided in the Detailed Description section by way of illustrative examples.

In general, in one aspect, the invention provides a method of bonding a CL and an alkaline cell membrane of an AMFC wherein a chemical bond is created across an interface between the CL and the membrane. In one embodiment of the invention, the method includes formulating a catalyst ink for application to a surface of the cell membrane that includes one or more components having cross-linking functionality. In one embodiment of the catalyst ink formulation according to the invention, the formulation includes one or more components having cross-linking functionality including, but not limited to, one or more diamines and/or triamines. In another embodiment of the invention, one or more components having cross-linking functionality may be also introduced into the cell membrane chemical structure. The method further includes applying or casting the catalyst ink formulation onto at least a portion of a surface of the cell membrane.

In another embodiment of the invention, a method of chemically bonding a CL and a cell membrane of an AMFC includes applying a thin film to a surface of the cell membrane prior to application of the catalyst ink, wherein the thin film chemical structure includes one or more components that will help to induce and generate cross-linking across the membrane/thin film/CL interface. The method includes applying the thin film to the membrane surface and applying or casting subsequently a catalyst ink formulation onto the thin film to form the CL and achieve cross-linking across the membrane/thin film/CL interface. In a further embodiment of the invention, a method of chemically bonding a CL and a cell membrane of an AMFC includes adding precursor functional groups to a catalyst ink formulation and/or to a thin film that has been pre-applied to a surface of the cell membrane. The method further includes, subsequent to applying or casting the catalyst ink formulation and/or the thin film and catalyst layer onto the membrane surface, curing of the interface with application of ultraviolet (UV) light or heat, to generate chemical bonding between the UV, or heat activated functional groups across the CL/membrane, or the CL/thin film/membrane interface.

In the embodiments described above, the method may include a pre-treatment of the cell membrane surface before applying a thin film to the surface. Such surface pre-treatment may include, but is not limited to, roughening the membrane surface via micro-particle sand blasting, and/or swelling of a portion or a region of the membrane surface via contacting the portion or region with one or more solvents suitable for inducing swelling under controlled application conditions such as DMF, n-propanol, i-propanol, DMAC, and THF.

In general, in an aspect, an embodiment of the present invention may provide at least one catalyst coated (CCM) for an alkaline membrane fuel cell (AMFC) comprising at least one OH-ion conducting catalyst layer and an ion-conducting membrane, wherein the ionomer throughout the entire CCM is cross-linked in one chemical step including cross-linking within the ion-conducting membrane and catalyst layers, while enabling simultaneous chemical bonding across the interfaces between at least one catalyst layer and the ion-conducting membrane.

In another aspect, cross-linking is introduced across a precursor form of the CCM, including a membrane in precursor form catalyzed on each of its sides by catalyst layers containing ionomers precursor and where conversion of the CCM to ionic form may be performed simultaneously with the cross-linking step.

In another aspect, a thin film of non-ionic conducting precursor polymer may be mixed with metal or oxide catalysts deposited on both sides of a thin ion conducting polymer membrane and this precursor CCM cross-linked through the full thickness.

In another aspect, the thin non-ion conducting polymer membrane thickness may be in between 40 microns and 3 microns, more preferably in between 30 microns and 5 microns.

In another aspect the cross-linking functionality is introduced into the overall CCM structure.

In yet another aspect the cross-linking functionality introduced into the overall membrane structure converts the entire alkaline membrane fuel cell non-ion conducting precursor CCM into an alkaline membrane fuel cell anion conducting CCM cell.

In another aspect, the CCM is a continuous cross-linked polymer structure, in which no polymer interfaces are distinguishable.

In another aspect, the cross-linked structure is achieved by using in the catalyst layers a mixture of anion conducting ionomeric materials with chloride or bromide forms of ionomeric precursor material.

In another aspect, the chloride and/or bromide and/or iodide form precursor material s may entrap the anion conductive ionomeric materials when the cross-linked structure is formed.

In another aspect, the chloride and/or bromide and/or iodide forms of the ionomer precursors may be simple or branched hydrocarbon based polymers.

In yet another aspect, the branched hydrocarbon polymers may have the capability to form multiple quaternary ammonium dendrimer structures to be cross-linked into the CCM structure.

In general, in an aspect, embodiment of the present invention may provide a method of forming the alkaline membrane fuel cell anion conducting CCM cell, the method comprising: (i) soaking the whole alkaline membrane fuel cell CCM precursor into a solution or dispersion of (a) an anion conductive ionomer material, and (b) amine compound mixture to form a fully functionalized and cross-linked CCM in precursor form (ii) further soaking and washing the fully functionalized CCM in sulfuric acid (iii) further soaking and washing the fully functionalized CCM in sodium or potassium bicarbonate aqueous solution (iv) further soaking and washing the fully functionalized CCM in water (v) further drying of the fully functionalized CCM at room temperature (vi) compressing the fully functionalized dried CCM at room temperature.

In another aspect, the amine based compound mixture may comprise at least two of the following types of compounds: (a) monoamine and/or linear diamine (b) free base tetrakis pyridinium porphyrin, free base tripyridinium porphyrin, free base dipyridinium porphyrin (c) branched polyethyleneimine, polypropyleneimine dendrimers (d) free base tetrakis pyrrolidinium porphyrin, free base triprrolidinium porphyrin, free base dipyrrolidinium porphyrin (e) free base tetrakis morpholinium porphyrin, free base trimorpholinium porphyrin, free base dimorpholinium porphyrin.

In another aspect, wherein the amine based compound mixture comprises: (a) Monoamine and/or linear diamine; (b) Metal based tetrakis pyridinium porphyrin, metal based tripyridinium porhyrin, metal based dipyridinium porphyrin

In another aspect, the metal may be one or more of copper, manganese, iron, or cobalt.

In yet another aspect, the method of activating the alkaline membrane fuel cell anion conductive CCM cell requires no soaking of KOH and/or NaOH and/or any other hydroxyl liquid solution.

In another aspect, the OH— anions are formed from the carbonate form in-situ in the operating cell by passing cell current.

In another aspect, the method of activating further includes a high current step to start formation of OH— inside the cell.

In another aspect, a membrane electrode assembly for alkaline membrane fuel cell is fabricated including a CCM as set forth herein and a pair of gas diffusion layers (GDL).

In another aspect, an alkaline membrane fuel cell stack is fabricated that includes a plurality of membrane electrode assemblies.

In another aspect, the CCM is incorporated in an alkaline membrane electrolyzer (AME) to generate hydrogen and oxygen from water.

In yet another aspect, the OH-anion are formed in-situ from the carbonate form during activation of the AME by an initial passage of a high current.

In yet another aspect, the CCM further includes current collectors comprising a porous metal to smooth release of gases.

In another aspect, the CCM further includes a AME stack comprising a plurality of AMEs.

In yet another aspect, the AME described herein does not require the presence of precious metal catalysts.

Some embodiments of the invention may be related to a catalyst coated membrane (CCM) for an alkaline exchange membrane fuel cell. The CCM may include a membrane including at least one of: a polymer or a copolymer having a first functional chemical group; an anode catalyst layer coated on one side of the membrane including: anode catalyst nano-particles and a polymer or a copolymer having a second functional chemical group; and a cathode catalyst layer coated on a side of the membrane opposite the anode catalyst layer, including: cathode catalyst nano-particles and a polymer or a copolymer having a third functional chemical group. In some embodiments, the first functional chemical group, the second functional chemical group and the third functional chemical group may each be crosslinked with a crosslinking chemical group. In some embodiments, the anode catalyst layer may be bonded to the membrane with the crosslinking chemical group and the cathode catalyst layer may be bonded to the membrane with the crosslinking chemical group, such that the same crosslinking chemical bonds are found in the membrane, the catalyst layers and the interfaces between the membrane and the catalyst layers.

In some embodiments, the first functional chemical group, the second functional chemical group and the third functional chemical group may all be the same functional chemical group. In some embodiments, the functional chemical group is benzyl chloride functional groups. In some embodiments, the crosslinking chemical group may include a diamine. In some embodiments, the crosslinking chemical bonds are quaternary amine groups.

In some embodiments, the membrane may further include porous mesh. In some embodiments, at least one of: the cathode catalyst layer and the anode catalyst layer may include a support material for supporting the catalyst nano-particles.

Some embodiments of the invention may related to a method of making a catalyst coated membrane (CCM) for an alkaline exchange membrane fuel cell. Embodiments of the method may include coating a membrane comprising at least one of: a precursor of a polymer or a precursor of a copolymer having a first functional chemical group with an anode catalyst layer on one side of the membrane and a cathode catalyst layer on side of the membrane opposite the anode catalyst layer. In some embodiments, the anode catalyst layer may include: anode catalyst nano-particles and a precursor of a polymer or a precursor of a copolymer having a second functional chemical group and the cathode catalyst layer may include cathode catalyst nano-particles and a precursor of a polymer or a precursor of a copolymer having a third functional chemical group. Embodiments of the method may further include immersing the coated membrane is a liquid matrix comprising a crosslinking agent that is configured to chemically react with the first functional chemical group, the second functional chemical group and the third functional chemical group and crosslinking all the functional groups of the coated membrane simultaneously.

In some embodiments, the first functional chemical group, the second functional chemical group and the third functional chemical group may be the same functional chemical groups. In some embodiments, the functional chemical group may be benzyl chloride. In some embodiments, wherein the liquid matrix is: a liquid diamine or a dispersion of a diamine in water, ethanol, methanol, dimethyl formamide or a mixture thereof.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic diagram of an AMFC.

FIGS. 2a-2b are schematic diagrams of AMFCs with chemical bonding.

FIG. 3 is a schematic diagram of an example of a diphosphine cross-linked CL/membrane interface in an AMFC.

FIG. 4 is a schematic diagram of an example of a diphosphine cross-linked interface of CL and cell membrane through a cross-linked thin film.

FIG. 5 is a schematic diagram of an example of a diphosphine cross-linked CL/membrane interface, established through a cross-linked, thin polymer film of acidic functions.

FIG. 6 shows an exemplary ionic cross-linking effect based on the ionic force of attraction between a negative sulfonate ion and a positive tetra alkyl ammonium ion interacting at the CL/cell membrane interface.

FIG. 7 is a schematic diagram of an example of a UV cross-linked interface of quaternary phosphonium based CL and cell membrane, using diercaptohexane as cross-linking agent.

FIG. 8 is a schematic diagram of an example of an intelface involving a CL and membrane with quaternary phosphonium cations, using chloroacetyl groups as thermal cross-linking agent.

FIG. 9 is a schematic diagram of a CCM for an AMFC with chemical bonding between the CL and the membrane interface and through the CL and further through the membrane itself and the CL on the other side of the membrane.

FIG. 10 is a table illustrating the operation of the embodiment of FIG. 9 of the invention.

FIG. 11 is a flowchart of a method of making the CCM illustrated in FIG. 9 according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

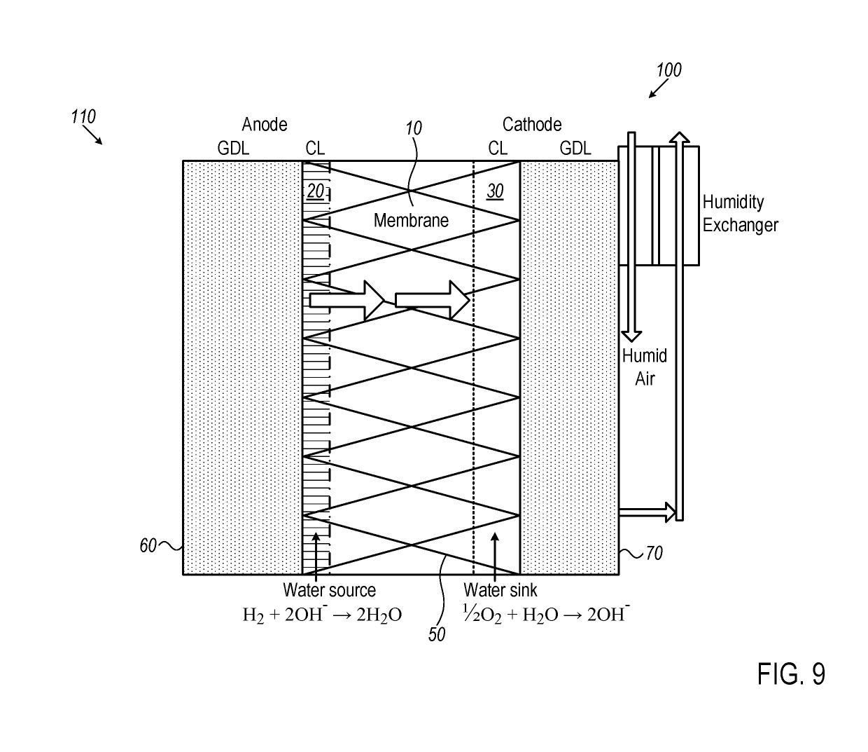

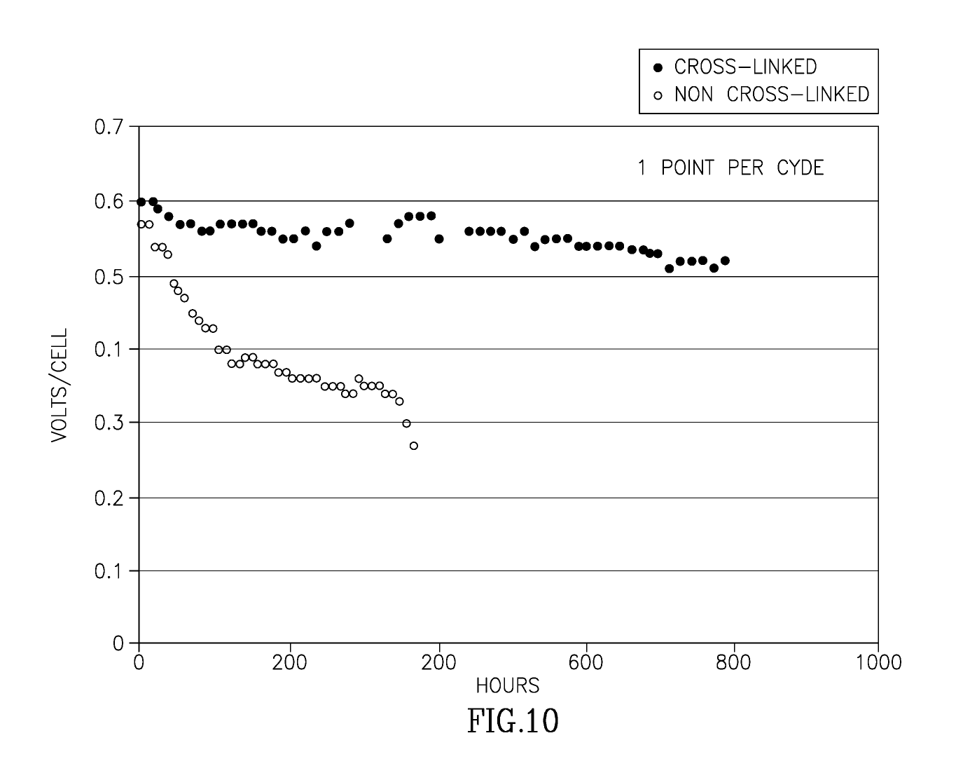

Embodiments of the invention may provide methods of chemically bonding a CL and a cell membrane of an alkaline membrane fuel cell (AMFC) at or across an interface of the CL and a surface of the cell membrane. Other embodiments are within the scope of the invention. Further, embodiments of the invention may provide a CCM for an AMFC having an OH-ion conducting catalyst layer and associated membrane where the ionomer throughout the entire CCM is cross-linked in one chemical step including cross-linking within the membrane and within the catalyst layers, thus enabling simultaneous bonding across the interface between the catalyst layers and the ion conducting membrane, as shown in FIG. 9. The through-the-CCM cross-linking can be achieved by a one step chemical treatment involving both cross-linking and functionalization, applied to a precursor-form CCM.

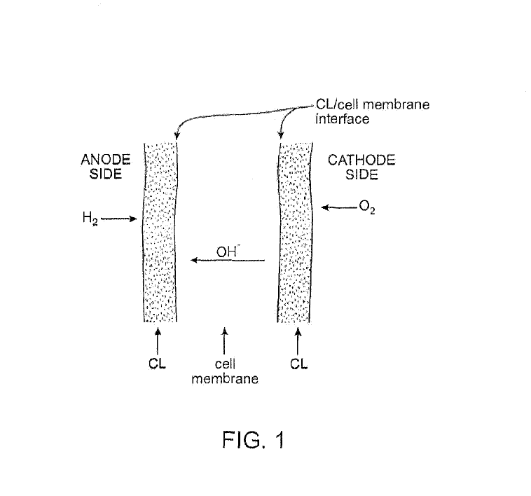

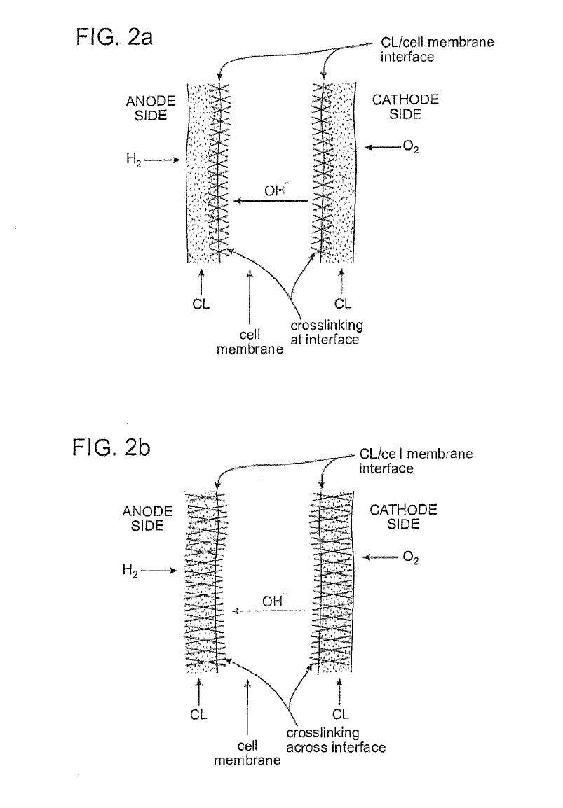

FIG. 1 shows a schematic diagram of an AMFC where the CL/membrane contact is established using thermo-mechanical tools alone. FIG. 2 shows a schematic diagram of an AMFC with chemical bonding between the CL and membrane surface in which the chemical bonding is across the CL-cell membrane interface, where the cross-linking based bond may be confined to the interface alone (e.g., FIG. 2a) and/or also involve some volume of the catalyst layer (e.g., FIG. 2b).

Further, the invention provides a CCM for an AMFC having an OH-ion conducting catalyst layer and associated membrane wherein the ionomer throughout the entire CCM is cross-linked in one chemical step including cross-linking within the membrane and within the catalyst layers, thus enabling simultaneous bonding across the interface between the catalyst layer and the ion conducting membrane, as shown in FIG. 9.

Below are descriptions of examples of the methods and processes according to the invention and are provided as illustrative examples only and are not intended to limit the scope of the invention as described herein.

As used herein, “alkyl”, “C1, C2, C3, C4, Cs or C6 alkyl” or “C1-C 6 alkyl” is intended to include C₁, C₂, C₃, C₄, Cs or C₆ straight chain (linear) saturated aliphatic hydrocarbon groups and C₃, C₄, Cs or C₆ branched saturated aliphatic hydrocarbon groups. For example, C₁-C₆ alkyl is intended to include C₁, C₂, C₃, C₄, Cs and C₆ alkyl groups. Examples of alkyl include, moieties having from one to six carbon atoms, such as, but not limited to, methyl, ethyl, n-propyl, i-propyl, n-butyl, s-butyl, t-butyl, n-pentyl, s-pentyl or n-hexyl.

In certain embodiments, a straight chain or branched alkyl has six or fewer carbon atoms (e.g., C1-C6 for straight chain, C₃-C₆ for branched chain), and in another embodiment, a straight chain or branched alkyl has four or fewer carbon atoms.

In one embodiment, the alkyl group may be chemically linked to the backbone of the ionomers of the CL. For example, the alkyl group may be chemically linked to the hydrocarbon backbone of the ionomers of the CL.

In another embodiment, the alkyl group may be chemically linked to polymer structure of the membrane. For example, the alkyl group may be chemically linked to the hydrocarbon backbone of the membrane.

As used herein, “chemically linked,” for example, refers to any manner in which the alkyl group may be linked to the backbone of the ionomers of the CL or the backbone of the polymer structure of the membrane. For example, the alkyl group may be covalently linked to the backbone of the ionomers of the CL or the backbone of the polymer structure of the membrane through a covalent chemical bond, e.g., a C—C bond.

As used herein, “spacer” or “a spacer group”, is, for example, intended to include any group known in the art used to optimize the length of a polymer molecule. In one embodiment, a spacer may be a polymer used in the art to optimize the length of a polymer molecule. In another embodiment, a spacer may be a hydrocarbon chain of certain length. For example, a spacer may be an alkyl chain (e.g., —CHr, —CH₂CHr, —CH₂CH₂CHr, —CHCH₃CHr, —CH₂CH₂CH₂CHr, —CHCH3CH2CHr, —C(CH3) 2CHr, —CH2CH2CH2CH2CHr, —CHCH3CH2CH2CHr or —CH2CH2CH2CH2CH2CH2-).

### Example 1

Embodiments of the invention may provide a method of chemically bonding a CL to at least a portion of a surface of an AMFC membrane at an interface between the CL and the portion of the membrane surface. Embodiments may include formulating a catalyst ink for application to the portion of the membrane surface where the ink includes at least one ionomer and one or more compounds or agents containing one or more cross-linking groups. The ionomer and the one or more cross-linking compounds or agents may be mixed at a pre-determined ratio when preparing the ink. The one or more compounds or agents include compounds having one or more cross-linking groups suitable for chemically linking of one or more ionomeric functionalities of the CL and the cell membrane, across the CL/cell membrane interface. Upon application of a catalyst ink of such formulation to at least a portion of the membrane surface, the cross-linking groups of the compounds or agents of the ink formulation chemically bond to one or more ionomer functional groups in the cell membrane, thereby preferably establishing a well-bonded CL/membrane interface of low contact resistance. Similarly, the cell membrane may be formed from a formulation including one or more ionomeric materials and one or more chemical components having one or more cross-linking groups suitable for chemically linking to one or more ionomeric functionalities of the catalyst layer ink formulation.

The one or more compounds or agents of the catalyst ink formulation having cross-linking capacity may include, but are not limited to, diphosphines, triphosphines, monophosphine and diphosphines mixtures, diamines, triamines, monoamine and diamine mixtures, and any phosphine or amine having the general formula: (R1R2)X—R—X(R3R4) where X is P or N atom, R1 and R2, R3 and R4 are C1-C6 alkyl groups, independent of each other or which form a ring between each other; and R includes a “spacer” in the molecular structure and is selected to optimize the length of the polymer molecule. Examples of such compounds are e.g., hexaphenylbutanediphosphine (HPBDP), diethyl-dimethylbutane diamine (DEDMBDA) or other linear diamines. In addition, the one or more compounds or agents may include non-linear diphosphine or diamines, e.g., quinuclidine or diazabicyclooctane (DABCO), alone or in combination with a monoamine. Further, the one or more compounds or agents may also include, but are not limited to, triallyl cyanurate, trimethylolpropane triacrylate, pentaerythritol triallylether, pentaerythritol tetrallylether, etc.

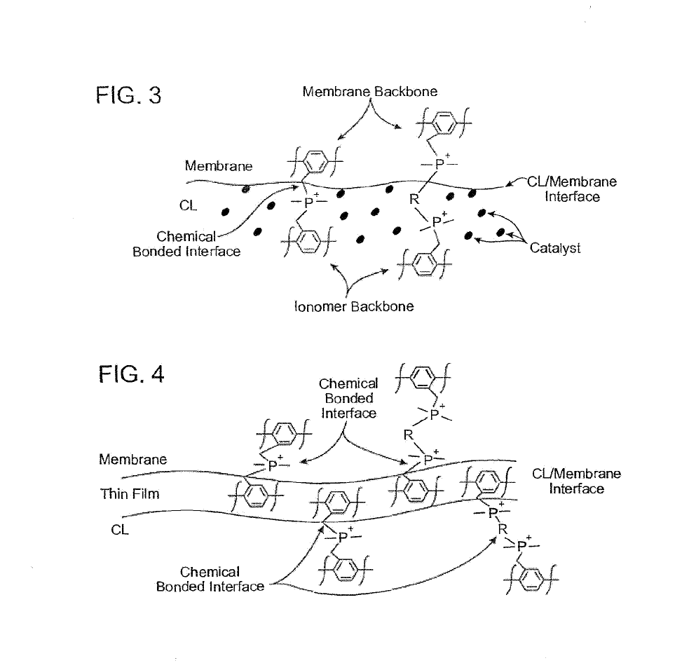

FIG. 3 shows a schematic diagram of a specific example of a diphosphine cross-linked CL/membrane interface in an AMFC.

### Example 2

Some embodiments may include formulating a thin surface film including at least one anion-conducting ionomer and containing one or more diphosphines, triphosphines, monophosphine and diphosphines mixtures, diamines, triamines, monoamine and diamine mixtures functional groups that facilitate cross-linking. The method can further include applying or casting the thin film onto at least a portion of the surface of the cell membrane before application of a catalyst ink formulation to the membrane surface to form a CL along the membrane surface. The thin film may have a thickness ranging from about 0.02 micrometer to about 1 micrometer, and about 0.1 micrometer. The functional groups may be provided by any of the compounds or agents described above in Example 1. The method can further include applying or casting the catalyst ink formulation onto at least a portion of the surface of the membrane pre-covered by the thin film Bonding between the CL and the membrane surface is achieved by cross-linking functional groups in the thin film with functional groups located at the surface of the membrane and the surface of the CL adjacent the thin film. The ionomer formulations and chemical structure of the CL and the cell membrane thereby remain practically unmodified despite such cross-linking and any undesirable effects of cross-linking on the ionic conductivity through the thickness of the CL and the cell membrane are minimized or prevented. FIG. 4 shows a schematic diagram of a specific example of a diphosphine cross-linked interface of CL and cell membrane through a cross-linked thin film.

### Example 3

Some embodiments may include formulating a thin surface film as described above in Example 2. Applying or casting the thin film onto a portion of the membrane surface is followed by applying or casting a catalyst ink which includes an ionomer mixed at a pre-determined ratio with one or more compounds or agents containing one or more cross linking capable groups, suitable for chemically linking with one or more ionomeric functions, of the ionomeric material(s) in the thin film Cross-linking can occur at the interfacial contact between the catalyst ink and the thin film.

### Example 4

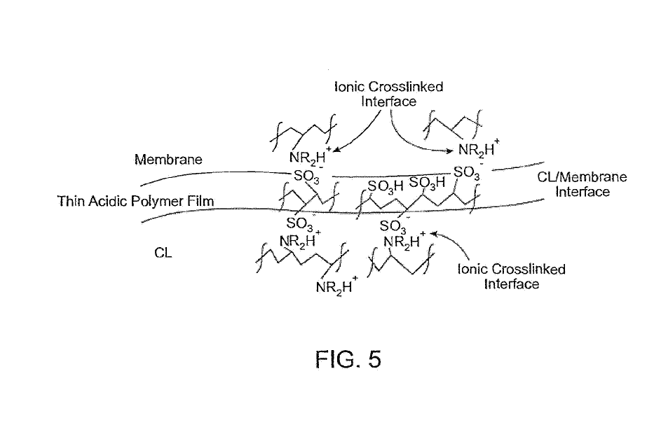

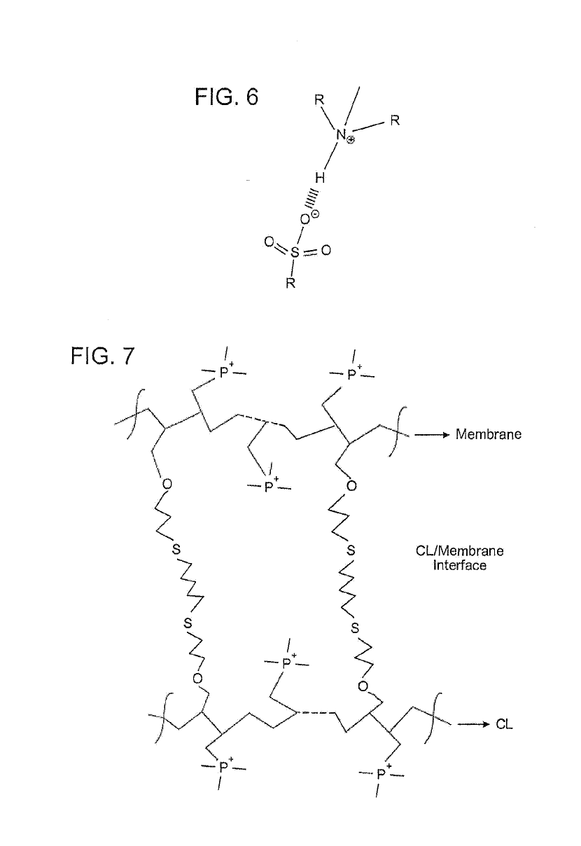

Some embodiments may include formulating a thin surface film as described above in Example 2; however, the cross linking functionality can be provided by an acidic polymer. The acidic polymer may include, but is not limited to, Nafion® or other molecule having the general formula: Ac1-R-Ac2, where Ac1 and Ac2 are acidic functional groups, such as, for instance, —COOH, —S03H, or other acidic group. Ac1 and Ac2 can be the same or different groups. The method includes applying or casting the thin film onto at least a portion of the surface of the cell membrane before application of a catalyst ink formulation to the thin film-covered membrane surface. Application of the thin film results in an acid-base reaction at the interface of the thin film and the cell membrane. The reaction occurs between the OH— ions of the alkaline ionomer of the cell membrane and the H+ ions of the acidic polymer of the thin film. The acid-base reaction can result in electrostatic bonds between the quaternary phosphonium R3HP+ ions (or the quaternary ammonium R3HN+ ions) in the anion conducting ionomer of the cell membrane and, for instance, the SO₃⁻² ions or COO⁻ ions of the acidic polymer of the thin film After application of the thin film, the method includes applying the catalyst ink formulation to the thin film. Similarly, an acid-base reaction can result at the interface of the thin film and catalyst layer, between the OH— ions of the CL ionomer and the H+ ions of the acidic polymer contained in the thin film to produce electrostatic bonds between R4P+ ions or R4 N+ ions in the anion conducting ionomer and the SO₃⁻² ions or COO⁻ ions of the acidic polymer. The acidic polymer of the thin film thereby has the capacity to “tie” the surface of the CL to the surface of the cell membrane, by the electrostatic bonds formed at the interfaces between the thin film and cell membrane and the thin film and CL. FIG. 5 shows a schematic diagram of a specific example of a diphosphine cross-linked CL/membrane interface, established through a cross-linked, thin polymer film of acidic functions. FIG. 6 shows the specific ionic cross-linking effect based on the ionic force of attraction between a negative sulfonate ion and a positive tetra alkyl ammonium ion interacting at the CL/cell membrane interface.

### Example 5

Some embodiments may include formulating a thin surface film including UV absorbing functions provided by compounds having one or more UV sensitive groups. UV sensitive groups can include, for instance, UV initiators, as components of the thin film composition that facilitate UV-induced cross linking. Such UV sensitive groups can include, but are not limited to, epoxy or/and acrylate groups, e.g., of standard UV curing material(s) or unsaturated esters used in UV-curing adhesive technology, e.g., glycidylmethacrylate, pentaerylthritol triallylether, triallyl cyanurate, allylpentaerythritol (APE) and/or dimercaptohexane (hexanedithiol), mixed with an appropriate photo initiator, e.g., 2-Hydroxy-2-methyl-1-phenyl-propan-1-one (Darocur® 173), Phenylglyoxylate (Darocur MBF®), benzophenone (Darocur BP®), 2-hydroxy-1-[4-(2-hydroxyethoxy)phenyl]-2-methyl-1-propanone (Lrgacure® 2959), etc. The method can include applying or casting the thin film with UV sensitive groups onto at least a portion of the surface of the cell membrane before application of a catalyst ink formulation to the thin film-covered membrane surface. The cross-linking agent and UV initiator are added in low concentrations, for example <20 wt % and more less than 5 wt % of the polymer content during thin-film casting. Subsequent to application of the thin film, the method can include applying the catalyst ink formulation onto the thin film and thereafter applying UV radiation to the membrane, the catalyst layer and the thin film. The exposure to UV can be for a few minutes, for example, for less than 10 minutes. UV radiation can facilitate cross linking of the UV sensitive groups in the thin film thereby establishing chemical bonding of the CL to the surface of the membrane via the thin film Applying UV radiation may include irradiating the cell membrane with UV radiation from the side of the membrane that has not been catalyzed. UV radiation absorption by the membrane is typically less than absorption by the metal-containing CL. Therefore, sufficient UV energy will hit the interface of the CL and the cell membrane and thereby trigger advantageously the cross linking between the CL and the membrane to chemically bond the CL and the membrane across the interface. One advantage of UV-induced cross linking as described is that such cross linking can be achieved at low temperatures, e.g., room temperatures, and such process can thereby avoid any degradation of temperature-sensitive polymers. FIG. 7 shows a schematic diagram of a specific example of a UV cross-linked interface of quaternary phosphonium based CL and cell membrane, using dimercaptohexane as cross-linking agent.

### Example 6

A chemical composition of the catalyst ink and/or of the cell membrane may include one or more UV initiators to introduce the precursor functionalities of UV-induced cross linking as described above. Bonding at the interfacial contact of the catalyst ionomer and the cell membrane is achieved with application of UV radiation after the catalyst ink formulation has been applied to at least a portion of the surface of the cell membrane to form the CL.

### Example 7

Some embodiments may include applying or casting onto at least a portion of the surface of the cell membrane a thin film containing one or more compounds providing UV-induced cross linking functionalities and one or more UV initiators as described above in Example 5. The method can further include applying a catalyst ink formulation as described in Example 6, including one or more UV initiators intermixed with the one or more ionomers of the catalyst ink formulation to introduce UV-induced cross linking functionalities. The method can include applying or casting the catalyst ink formulation onto the thin film and thereafter applying UV radiation to facilitate UV cross linking.

### Example 8

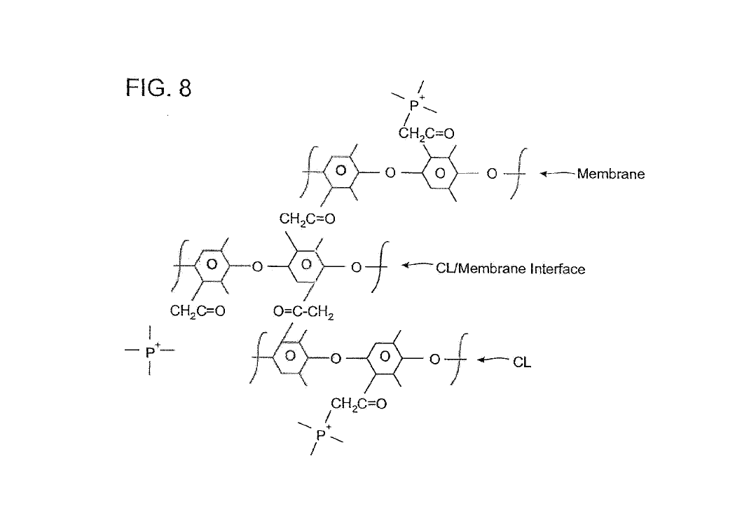

Some embodiments may include formulating a thin surface film including at least one anion-conducting ionomer and containing one or more compounds having constituents that provide thermal cross linking upon heating. The method can also include applying or casting the thin film onto at least a portion of the surface of the cell membrane before application of a catalyst ink formulation to the thin-film covered membrane surface. Such one or more compounds having constituents that provide thermally induced cross linking include polymers suitable for functionalizing with anionic groups, while remaining stable in mild alkaline environments, and for achieving thermal cross linking and bonding at relatively low temperatures, such as, forinstance, temperatures within a range of from about 25° to about 120° C. For example, one such polymer is polyphenyleneoxide (PPO), either chloroacetylated, bromomethylated or aminated to form a polysulfone-based polymer ionomer with OH-ion conductivity. In contrast to the ionomer, PPO can be cross linked at temperatures in a range from about 60° C. to about 90° C. FIG. 8 shows a schematic diagram of a specific example of an interface involving a CL and membrane with quaternary phosphonium cations, using chloroacetyl groups as thermal cross-linking agent.

### Example 9

Some embodiments may include formulating the cell membrane composition as a blend of one or more polymers configured for thermal cross linking in response to applications of heat and one or more ionomers configured for OH— ion conductivity. The composition of the cell membrane in this embodiment can provide advantageous separate control of the membrane's conductivity and the degree of cross-linking.

As previously mentioned above, according to some embodiments of the present invention one or more components having cross-linking functionality may be introduced into the cell membrane chemical structure itself.

Thus, some embodiments of the present invention may provide a method of stabilizing a catalyst coated membrane (CCM) for an Alkaline Membrane Fuel Cell (AMFC). The stabilization is accomplished by cross-linking the ionomer through the entire CCM. The cross-linking bonding affects not just the stability of the CCM through inter-chain bonding in the ionomeric phases, but also through the bonding across catalyst layer (CL)/membrane (M) interfaces. In one embodiment, the method includes formulating a catalyst ink for application to a surface of the cell membrane that includes one or more components having cross-linking functionality. The cross-linking functionality is introduced into each of the CLs of the AMFC, and also into the cell membrane chemical structure. This method further includes applying or printing the catalyst ink formulation using ionomer precursors onto each surface of the cell membrane precursor.

Referring to FIG. 9, which is an illustration of a CCM for an alkaline exchange membrane fuel cell according to some embodiments of the invention, CCM 100 may include a membrane 10, an anode catalyst layer 20 coated on one side of membrane 10 and a cathode catalyst layer 30 coated on the opposite side of membrane 10. In some embodiments, CCM 100 may be included in alkaline exchange membrane fuel cell 110 that may further include an anode GDL 60 and a cathode GDL 70. In some embodiments, membrane 10 may include at least one of: a polymer or a copolymer having a first functional chemical group, such as alkyl halide (e.g., chloromethyl or bromohexyl functional groups and the like). For example, membrane 10 may include a copolymer of polystyrene-co-poly(vinylbenzyl chloride). In some embodiments, the polymer or a copolymer may be infused in a porous mesh, for example, an expanded PTFB.

Anode catalyst layer 20 may include anode catalyst nano-particles (e.g., Pd, Pt, Ru, Ag, and their alloys) and a polymer or a copolymer having a second functional chemical group, for example, alkyl halide such as, chloromethyl or bromohexyl functional groups and the like. For example, anode catalyst layer 20 may include catalytically active nanoparticles and poly(vinylbenzyl chloride). In some embodiments, the catalyst nano-particles may be supported on a conductive support, for example, each catalyst nano-particle may be supported (e.g., attached) to a conductive substrate (e.g., carbon, nickel and the like, which may be in the form of nanoparticles).

Cathode catalyst layer 30 may include cathode catalyst nano-particles (e.g., Pd, Pt, Ru, Ag, and their alloys) and a polymer or a copolymer having a third functional chemical group, for example, alkyl halide such as, chloromethyl or alkyl halide functional groups and the like. For example, cathode catalyst layer 30 may include catalytically active nanoparticles and poly(vinylbenzyl chloride). In some embodiments, the catalyst nano-particles may be supported on a conductive support, for example, each catalyst nano-particle may be supported (e.g., attached) to conductive nanoparticle (e.g., carbon, nickel and the like).

In some embodiments, the functional chemical groups in the polymer or the co-polymer of the membrane, the functional chemical groups in the polymer or the copolymer in the anode catalyst layer and the functional chemical groups in the polymer or co-polymer of the cathode catalyst layer are the same type of functional chemical group, for example, benzyl halide, alkyl halide, or various substituted alkyl chains containing one or more alkyl halide group.

In some embodiments, the first functional group of the polymer or a copolymer of membrane 10 may include chloromethyl functional groups and the second functional group of the polymer or a copolymer of membrane 20 may include bromohexyl functional groups and the third functional group of the polymer or a copolymer of membrane 30 may include bromomethyl.

In some embodiments, the first functional chemical groups, the second functional chemical groups and the third functional chemical groups of CCM 100 may be all crosslinked and bonded using the same crosslinking chemical groups, such that the same crosslinking chemical bonds 50 are found in the membrane, the anode and cathode catalyst layers and the interfaces between the membrane anode catalyst layer and the membrane and the cathode catalyst layer. In some embodiments, the crosslinking chemical groups may include diamines. In some embodiments, membrane 10 and catalyst layer 20 and 30 and the interfaces between membrane 10 and catalyst layer 20, and membrane 10 and catalyst layer 30 may all include crosslinking chemical bonds 50, for example, via quaternary amine groups covalently attached to benzyl or alkyl or substituted alkyl groups. Thus, we now describe an original approach to structural stabilization of a complete cell of an AMFC, including catalyst layers and a membrane, an entire and continuous anion conductive polymer structure. In some embodiments, methods for fabrication of CCMs for AMFCs, utilize special inks including of a mixture of non-ionic forms of polymer precursors mixed with electrocatalyst and solvent to form a THF or ethyl acetate dispersion. The ink may include catalyst and a non-ionic precursor form of an ionomer precursor and may be then applied onto a non-ionic precursor form of the membrane, to achieve on application a homogenized catalyst layer with good adhesion to the membrane precursor.

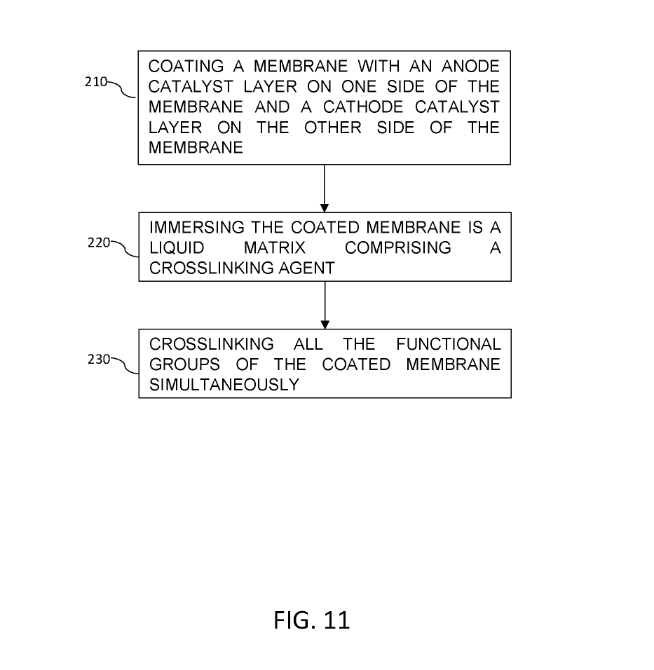

Reference is now made to FIG. 11 which is a flowchart of a method of making a catalyst coated membrane (CCM) (e.g., CCM 100) for alkaline exchange membrane fuel cell according to some embodiments of the invention. In box 210, a membrane (e.g., membrane 10) made from a precursor of a polymer or a precursor of a copolymer having first functional chemical groups may be coated with an anode catalyst layer (e.g., layer 20) on one side of the membrane and a cathode catalyst layer (e.g., layer 30) on the other side of the membrane. In some embodiments, an anode ink and a cathode ink each including a mixture of non-ionic forms of polymer precursors, the corresponding catalyst nanoparticles and solvent may be each be applied on one side of membrane 10. In some embodiments, the pre-prepared CCM may all include polymer precursors.

In box 220, the coated membrane may be immersed in a liquid matrix that includes a crosslinking agent. The crosslinking agent may be configured to chemically react with the first functional chemical groups included in membrane 10, the second functional chemical groups included in layer 20 and the third functional chemical groups included in layer 30. For example, the first functional group may include chloromethyl functional groups, the second functional group may include bromohexyl functional groups and the third functional group may include bromomethyl. In some embodiments, the first functional chemical groups, the second functional chemical groups and the third functional chemical groups may be the same functional chemical groups, for example, benzyl chloride functional groups. In some embodiments, the liquid matrix may be at least one of: a liquid diamine, a dispersion of the diamine in one of: water, ethanol, methanol and dimethyl formamide and the like. Some embodiments may further include, mixing and heating the liquid matrix for a predetermined amount of time to promote crosslinking.

In box 230, all the functional groups of the coated membrane may be crosslinked simultaneously. The liquid matrix containing the crosslinking agent may penetrate through the coated membrane. Therefore the crosslinking agent may be reacted simultaneously with the functional chemical groups of membrane 10, anode catalyst layer 20 and cathode catalyst layer 30 and with the functional chemical groups in the interface between membrane 10 and anode catalyst layer 20, and the interface between membrane 10 and cathode catalyst layer 30.

In some embodiments, the benzyl chloride functional group may be reacted with the diamine-type crosslinking agent consisting of, for example, N,N,N′,N′-tetramethyl-1,6-hexanediamine, via an amination reaction. In some embodiments, during the crosslinking the chlorides at the benzyl chloride functional may be replaced by quaternary amine groups covalently attached to the benzyl groups, for example, using the following reaction:

R—Cl+(CH3)2N—R′→R′—[R—(CH3)2N]⁺[Cl]⁻

In an experiment, a CCM (where the membrane and the catalyst layers included the same mixture) made of a mixture of N,N,N′,N′-tetramethyl-1,6-hexanediamine (TMHDA, 90 mol %) and trimethylamine (TMA, 10 mol %) in water was simultaneously quaternized and crosslinked with poly(vinylbenzyl chloride) to give a well-crosslinked CCM with high conductivity and complete amination. The mixture was immersed for 15 hours at room temperature.

In another experiment, TMHDA based CCM (where both the membrane and the anode and cathode catalyst layers included TMHDA) was dissolved in ethanol to react so as to form a well-crosslinked CCM for about 24 hours at 25° C. TMHDA based CCM was later aminated in TMA for another 24 hours to complete the quaternization.

The non-ionic forms of the polymers in both CLs and M contain chloride-based, bromide, or iodide functionalities, which allow further conversion to anionic form after the CCM is formed. The conversion to anionic form is then carried out simultaneously with the cross-linking, using a mixture of mono-amines and multifunctional amines. By doing this at the CCM level the cross-linking acts throughout all the entire CCM thickness dimension, meaning CLs, M and interfaces, in contrast to the prior art, in which cross-linking of interfaces has been the main target.

Such cross-linking method involving the CCM as a whole may allows further stabilization in the entire cell, not just at the interfaces. Such type of in-situ cross-linking and functionalization approach allows inter chain bonding within the ionomer phases together with interfacial bonding, resulting in well stabilized CCM and AMFC.

It has been found that it is likely that application of catalyst layer in precursor form onto a membrane in precursor form generates a better interfacial adhesion vs. application of a catalyst layer in ionic form to a membrane in ionic form. Consequently, the strength of the CL-M bond is pre-secured by superior adhesion in the precursor form of the unitized CCM, generating a better “interface preparation” for the subsequent cross-linking.

### Example 10

An ink containing a non-ion conducting precursor was formed by mixing a chloride-form precursor and catalyst dispersed in THF solvent, with and without carbon nanoparticles. The non-ionic polymer-catalyst dispersion mix was then homogenized using double process of high power sonication. Then, the mix was applied onto both sides of a precursor form membrane film, also based on chloride form hydrocarbon precursor, forming a non-ionic-based CCM all in precursor form. Then, simultaneous conversion to anionic form and cross-linking in the entire precursor-form CCM was generated by immersing the complete non-ionic CCM into a solvent mixture of various reactants.

The reactants, for instance, are a mixture of both linear diamine and a free base tetrakis pyridinium porphyrin. By immersing the entire non-ionic CCM into this solvent mixture, the solvent mixture penetrates into the entire non-ionic CCM. By warming the solvent mix bath to, for by way of example only, 40 C, the bases introduced with the solvent mix react with all the chloride sites in the entire precursor CCM imparting both ionic functionalization and cross-linking to all the polymer sites available in the CCM.

By allowing enough time for such simultaneous conversion to ionic form and cross-linking, by way of example only, 48 hours of immersion, the CCM formed is now a highly stable anion conducting CCM. At this stage, the anion conductive CCM is soaked in sulfuric acid solution. The purpose of this soaking is to remove all remaining unreacted amine and solvent from inside the CCM. To avoid to damage the catalysts in the CLs the acid needs to be properly chosen—for instance, HCl can damage the catalytic activity of some catalysts.

Next, the washed anion conductive CCM is further soaked into a sodium bicarbonate aqueous solution. The purpose of this soaking is to convert the so formed anion conductive CCM functional groups to carbonate form, washing at same time all the remaining sulfuric acid from inside the CCM. Finally, the anion conductive CCM in carbonate form is further washed in pure water, dried, and pressed at room temperature. The purpose of the final pressing step is to ensure electronic percolation in the CLs of the anion conductive CCM so formed, by improving the contact between metal catalyst particle.

The through-the-thickness cross-linked CCM exhibits robust characteristics in terms of minimized mechanical deformation as well as lower swelling-deswelling cycling deformation. For instance, by way of an example, it has been found that while a regular formed anion conductive CCM suffers a 3 mm deformation while applying a local pressure of 3 barg of hydrogen, a fully cross-linking anion conductive CCM formed by simultaneous functionalization and cross-linking all across the CCM as shown in this invention, has less than 0.5 mm deformation while applying a local pressure of 3 barg of hydrogen under the same CCM clamping conditions. Moreover, while a regular formed anion conductive CCM has a 20% deformation while applying swelling-deswelling cycles, a fully cross-linking anion conductive CCM formed by simultaneous functionalization and cross-linking all across the CCM as shown in this invention, has less than 8% of deformation while applying swelling-deswelling cycles. Finally, while a regular formed anion conductive CCM exhibits significant drop in performance after 200 hours of operation under real cell operation conditions in hydrogen-air mode of operation at constant power density demand of around 150 mW/cm2, a fully cross-linked anion conductive CCM formed by simultaneous functionalization and cross-linking all across the CCM as described in this invention, exhibits stability over more than 800 hours under same conditions. As an example, a fully cross-linked anion conductive CCM formed by simultaneous functionalization and cross-linking all across the CCM as shown in this invention, has been used to assembly a 6 cell AMFC stack, which was tested under on-off cycling switching between operation at 0 and 150 mW/, for 4 and 10 hours, respectively. The plot shown in FIG. 9 illustrates the cell voltage stability of the 6 cell stack.

Also, the method described in this invention does not require soaking the anion conductive CCM in any hydroxide solution, such as KOH, as required in prior art. The anion conductive CCM prepared by the method described in this invention can be activated without need of soaking it into NaOH or KOH. The anion conductive CCM formed by simultaneous functionalization and cross-linking across all the CCM can be formed into the final OH— form by in-situ activation alone using high current density steps. This important advantage of assembling the stack with the CCM in dry from and activating by current alone is thanks to the ability to activate with high current in-situ without damage by delamination as is likely in the case of less robust CCM structures.

It has been found that it is likely that application of catalyst layer in precursor form onto a membrane in precursor form generates a better interfacial adhesion vs. application of a catalyst layer in ionic form to a membrane in ionic form. Consequently, the strength of the CL-M bond is pre-secured by superior adhesion in the precursor form of the unitized CCM, generating a better “interface preparation” for the subsequent cross-linking.

Moreover, the CCM making techniques described herein can also be applied in alkaline membrane-based elctrolyzers (AME), in which anion conductive CCMs of the type taught above for fuel cells are used as the core component of an alkaline membrane-based electrolyzer for production of hydrogen from water. As in the case of AMFCs, electolyzers employing alkaline membranes enable use of non-precious metal catalysts. A robust CCM secured by the “across the CCM” bonding technique invention described here, will assist in the case of electrolyzer as well with rendering of good structural stability to the CCM and, hence, extending its useful life.

The methods according to the invention include forming or constructing membrane electrode assemblies (MEAs) for use in AMFCs including catalyst coated membranes (CCMs) as described in the above examples and further including gas diffusion layers (GDLs). In addition, the invention is not limited to the methods and processes disclosed herein and it is envisioned that the invention embodies and encompasses MEAs, CCMs and AMFCs including one or more of the cell membranes, thin films, and catalyst layers as described in the above examples.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A catalyst coated membrane (CCM) for an alkaline exchange membrane fuel cell comprising:
a membrane comprising at least one of: a polymer or a copolymer having a first functional chemical group;
an anode catalyst layer coated on one side of the membrane comprising: anode catalyst nano-particles and a polymer or a copolymer having a second functional chemical group; and
a cathode catalyst layer coated on a side of the membrane opposite the anode catalyst layer, comprising: cathode catalyst nano-particles and a polymer or a copolymer having a third functional chemical group,
wherein the first functional chemical group, the second functional chemical group and the third functional chemical group are each crosslinked with a crosslinking chemical group; and wherein the anode catalyst layer is bonded to the membrane with the crosslinking chemical group and the cathode catalyst layer is bonded to the membrane with the crosslinking chemical group, such that the same crosslinking chemical bonds are found in the membrane, the catalyst layers and the interfaces between the membrane and the catalyst layers.

2. The catalyst coated membrane of claim 1, wherein the first functional chemical group, the second functional chemical group and the third functional chemical group are the same functional chemical group.

3. The catalyst coated membrane of claim 2, wherein the functional chemical group is benzyl chloride functional groups.

4. The catalyst coated membrane of claim 3, wherein the crosslinking chemical group comprises a diamine.

5. The catalyst coated membrane of claim 1, wherein the crosslinking chemical bonds are quaternary amine groups covalently attached to benzyl groups.

6. The catalyst coated membrane of claim 1, wherein the membrane further includes porous mesh.

7. The catalyst coated membrane of claim 1, wherein at least one of: the cathode catalyst layer and the anode catalyst layer comprises a support material for supporting the catalyst nano-particles.

8. A method of making a catalyst coated membrane (CCM) for an alkaline exchange membrane fuel cell comprising:
coating a membrane comprising at least one of: a precursor of a polymer or a precursor of a copolymer having a first functional chemical group with an anode catalyst layer on one side of the membrane and a cathode catalyst layer on side of the membrane opposite the anode catalyst layer,
wherein the anode catalyst layer comprises: anode catalyst nano-particles and a precursor of a polymer or a precursor of a copolymer having a second functional chemical group; and
the cathode catalyst layer comprises: cathode catalyst nano-particles and a precursor of a polymer or a precursor of a copolymer having a third functional chemical group;
immersing the coated membrane is a liquid matrix comprising a crosslinking agent that is configured to chemically react with the first functional chemical group, the second functional chemical group and the third functional chemical group; and
crosslinking all the functional groups of the coated membrane simultaneously.

9. The method of claim 8, wherein the first functional chemical group, the second functional chemical group and the third functional chemical group are the same functional chemical groups.

10. The method of claim 9, wherein the functional chemical group is benzyl chloride.

11. The method of claim 10, wherein the liquid matrix is: a liquid diamine or a dispersion of a diamine in water, ethanol, methanol, dimethyl formamide or a mixture thereof.

12. The method of claim 9, wherein during the crosslinking, the chlorides of the benzyl chloride functional group are replaced by quaternary amine groups covalently attached to the benzyl groups.
